(19) United States
(12) Patent Application Publication
(10) Pub. No.: US 2021/0242550 A1
(43) Pub. Date: Aug. 5, 2021

(54) SYSTEM AND METHOD FOR MULTI-ELECTROLYTE ACTIVATION AND REFURBISHMENT OF ELECTROCHEMICAL CELLS

(71) Applicant: Central Intelligence Agency, Washington, DC (US)

(72) Inventors: Stefan C. Bradford, Washington, DC (US); Grant Umeda, Rockville, MD (US); Kirakodu S. Nanjundaswamy, Sterling, VA (US)

(73) Assignee: Central Intelligence Agency, Washington, DC (US)

(21) Appl. No.: 17/130,776

(22) Filed: Dec. 22, 2020

Related U.S. Application Data
(60) Provisional application No. 62/952,686, filed on Dec. 23, 2019.

(51) Int. Cl. H01M 50/609; H01M 10/0566; H01M 50/691

(52) U.S. Cl. CPC H01M 50/609; H01M 50/691; H01M 10/0566

(57) ABSTRACT

A method for multi-electrolyte activation or refurbishment of an electrochemical cell uses a first electrolyte to electrochemically decompose electrolyte components onto an electrode surface to create an electrode-electrolyte interphase (EEI). Once the EEI is created, the first electrolyte may be extracted so that a second electrolyte can be introduced into the electrochemical cell. The second electrolyte can interact with the EEI to optimize performance over a broader range of conditions than if the second electrolyte were interacting with the bare electrode. This method also allows for refurbishment of an electrochemical cell. Various structures may be provided on the electrochemical cell itself to facilitate the method.

### CLAIM TO PRIORITY

This application claims priority to Provisional Patent Application 62/952,686, titled “System and Method for Multi-Electrolyte Activation and Refurbishment of Electrochemical Cells”, filed on Dec. 23, 2019, the contents of which are hereby incorporated by reference in their entirety.

### STATEMENT OF GOVERNMENT SUPPORT

The United States Government has rights in this invention pursuant to the employer-employee relationship of the Government to at least one inventor.

### FIELD

The present subject matter relates generally to electrochemical cells. In particular, the present subject matter relates to methods for multi-electrolyte activation and refurbishment of an electrochemical cell and structures, such as sacrificial and/or reusable features that facilitate the method, as well as an electrochemical cell that includes the structures for optimizing and/or refurbishing the electrochemical cell, as well as an electrochemical cell that includes electrodes that have been optimized for a particular use with a unique electrode-electrolyte interphase (EEI), as well as the EEI-optimized electrodes themselves.

### BACKGROUND

Electrochemical cells may be stored and used in varying environmental conditions. Some of the environmental conditions may be extreme, such as high or low temperatures and high or low pressures. Usage conditions may also be extreme, such as rapid charge/discharge cycling and/or subjecting a cell to large discharge depths. In these conditions, cell performance or useful life may be diminished, in part due to the passivation or other modes of degradation of the electrode, such as loss of active materials to dissolution, loss of electrical contact, or any other mode(s) of degradation known to those of skill in the art.

### BRIEF DESCRIPTION OF THE DRAWINGS

A description of the present subject matter including various embodiments thereof is presented with reference to the accompanying drawings, the description not meaning to be considered limiting in any matter, wherein:

FIG. 1 is a diagram of a first method of an exemplary embodiment of a multi-electrolyte activation or refurbishment of an electrochemical cell;

FIG. 1A is a diagram of a second method of a second exemplary embodiment of a multi-electrolyte activation or refurbishment of an electrochemical cell;

FIG. 2 illustrates a perspective view of an exemplary embodiment of an electrochemical cell having structures to facilitate a multi-electrolyte activation or refurbishment of the electrochemical cell;

FIG. 3 illustrates a cut-away view of an exemplary embodiment of an electrochemical cell having structures to facilitate a multi-electrolyte activation or refurbishment of the electrochemical cell, showing a first electrolyte being introduced into the electrochemical cell;

FIG. 4 illustrates a cut-away view of an exemplary embodiment of an electrochemical cell having structures to facilitate a multi-electrolyte activation or refurbishment of the electrochemical cell, showing a first electrolyte being extracted from the electrochemical cell;

FIG. 5 illustrates a cut-away view of an exemplary embodiment of an electrochemical cell having structures to facilitate a multi-electrolyte activation or refurbishment of the electrochemical cell, showing a first electrolyte being introduced into the electrochemical cell;

FIG. 6 illustrates a schematic, enlarged view of a portion of an embodiment of a cell stack of an electrochemical cell showing an electrode-electrolyte interphase (EEI) on the cathode and anode layers;

FIG. 7 illustrates a perspective view of an exemplary embodiment of an electrochemical cell having structures to facilitate a multi-electrolyte activation or refurbishment of the electrochemical cell;

FIG. 8 shows an embodiment of a multi-electrolyte activation procedure use in a testing protocol of various embodiments of electrochemical cells configured for high temperature storage and use;

FIGS. 9a-c are graphs showing experimental results for various embodiments of electrochemical cells configured for high temperature storage and use having various charge voltage profiles;

FIGS. 10a-c are graphs showing experimental results for 50 degrees Celsius soak potentials of various embodiments of electrochemical cells configured for high temperature storage and use;

FIGS. 11a-c are graphs showing stabilization cycles of various embodiments of electrochemical cells configured for high temperature storage and use;

FIGS. 12a-c are graphs showing the final stabilization voltage profile for various embodiments of electrochemical cells configured for high temperature storage and use;

FIGS. 13a-c are graphs showing the self-discharge evaluation potentials for various embodiments of electrochemical cells configured for high temperature storage and use; and

FIG. 14 is a chart comparing the thickness growth at 85 degrees Celsius of embodiments of activated electrochemical cells having various electrolyte formulations.

### DETAILED DESCRIPTION

The methods and structures discussed herein and shown in the drawings are for multi-electrolyte activation or refurbishment of an electrochemical cell. Methods described herein generally describe introducing a first electrolyte into a cell that will, upon activation, electrochemically decompose electrolyte components onto an electrode surface to create an electrode-electrolyte interphase (EEI). Once the EEI is created, either directly after the EEI is created during activation or at the end of the useful life of the first electrolyte, at least a portion of the first electrolyte may be extracted so that a second electrolyte can be introduced into the electrochemical cell. The second electrolyte can interact with the EEI to efficiently perform and/or to optimize performance of the electrochemical cell over a broader range of conditions than if the second electrolyte were interacting with a bare electrode.

Some of these conditions include operation and storage in extreme temperatures, such as temperatures greater than about 60 degrees Celsius or below minus 20 degrees Celsius, high currents and/or voltages, large discharge depths, rapid charge/discharge cycling, extended storage shelf-life, and/or reduced self-discharge. In some cells, even small increases in temperature will have a major influence on performance. In certain cells, for example, for every 8.3° C. (15° F.) average annual temperature above 25° C. (77° F.), the life of the cell is reduced by approximately 50 percent. In other cells, for every 10° C. increase in temperature the reaction rate of undesired side-reactions doubles. Thus, an hour of operation at 35° C. is the same in terms of cell life as two hours of operation at 25° C. Methods described herein allow for optimization of the cell for operation at desired temperature or use conditions via a multiple electrolyte activation process during the initial manufacture of the electrochemical cell, and/or for refurbishment of the electrochemical cell if typical use, excessive use, or operation under extreme conditions caused degradation of the EEI and/or electrolyte over its lifetime. Such refurbishment may act in prolonging cell lifetime at a given temperature up to 200%. Various structures, either sacrificial or reusable structures such as fill tubes or sealing constructions, may be provided on or with the electrochemical cell itself to facilitate the methods.

Throughout the discussion below, use of the terms “about” and “approximately” are used to indicate engineering tolerances which would be well understood by a person of ordinary skill in the art for any particular application or embodiment. Further, while an order of the method steps is provided, this order is exemplary only; as will be recognized by those of skill in the art, the order of the method steps may be varied without impacting the overall efficacy of the method.

The present methods create a unique electrode-electrolyte interphase (EEI) to optimize performance of an electrochemical cell for specific conditions and/or to allow for refurbishment of a spent electrochemical cell. In some embodiments, the EEI is created by selecting a first electrolyte, introducing the first electrolyte into a cell, sealing the cell, and then activating the cell. Electrochemically activating the cell (i.e., charging to a specified voltage) causes selective components of the first electrolyte to decompose or otherwise react with the surface(s) of the cathode(s) and anode(s) of the cell. The seal of the electrochemical cell is then opened, and at least a portion of the remaining first electrolyte and any as-formed gases are extracted from the cell. In some examples, all or substantially all of the remaining first electrolyte and any as-formed gases are extracted. A second electrolyte having a different composition from the first electrolyte is then introduced into the cell. The second electrolyte is selected so that the unique EEI either optimizes the performance of the second electrolyte over a broader range of conditions or allows the second electrolyte to perform efficiently where passivation or other degradation of the electrode(s) may have occurred that would inhibit performance of other electrolyte compositions.

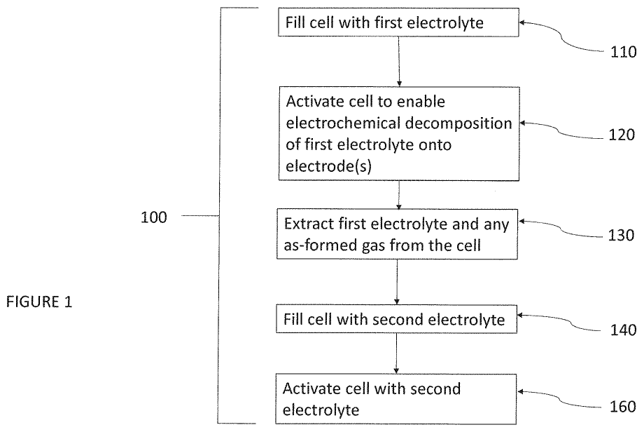

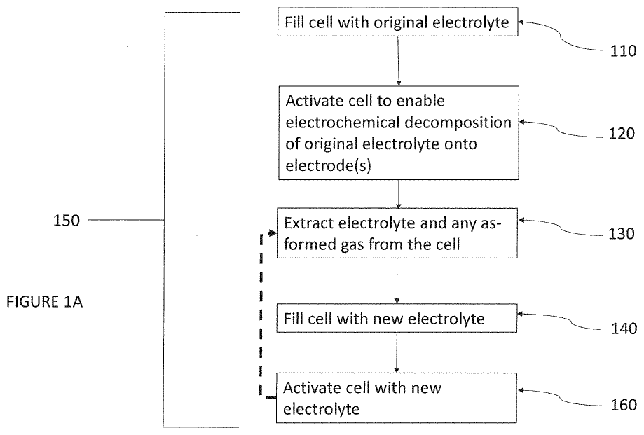

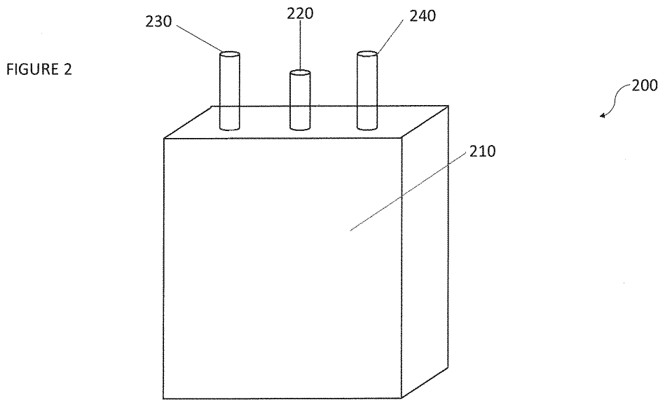

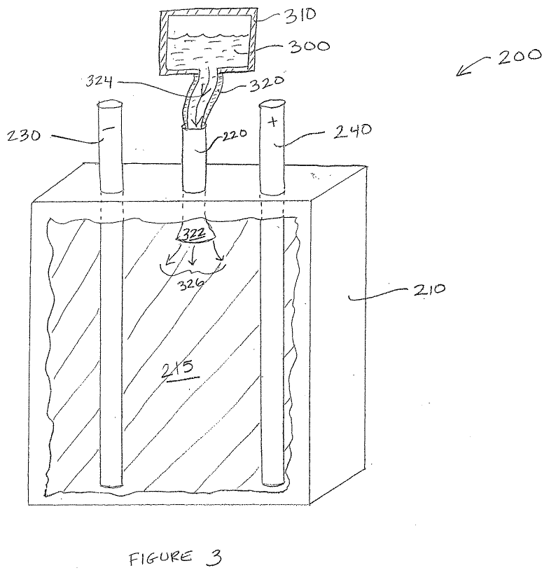

FIG. 1 shows various steps in an embodiment of a method 100 for creating the unique EEI on the electrodes of an electrochemical cell and using that unique EEI for ongoing use of the cell, to optimize performance and/or to refurbish the cell. In a first step 110, the first electrolyte, such as first electrolyte 300 shown in FIG. 3, is selected and introduced into an electrochemical cell, such as electrochemical cell 200 shown in FIG. 2. Electrochemical cell 200 may be any type of electrochemical cell known in the art, such as primary or secondary cell, lithium-ion cell, lithium-air cell, lithium-polymer cell, lithium-silicon cell, silver-oxide cell, lithium-sulfur cell, sodium-ion cell, lithium iron phosphate cell, lithium-ion polymer cell, sodium-sulfur cell, nickel-metal hydride cell, nickel-cadmium cell, nickel-zinc cell, lead-acid cell, magnesium cell, zinc-air cell, manganese cell, manganese dioxide-zinc cell, aluminum cell, multivalent cell, any other type of active metal electrode-electrolyte cell, or any other type of cell where an activation sequence could produce a desirable EEI on an electrode.

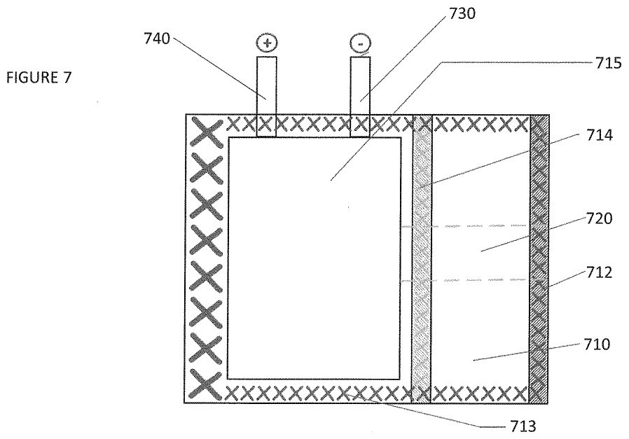

FIGS. 2-5 show an embodiment of an electrochemical cell 200 suitable for use in the present method such as method 100. Electrochemical cell 200 includes a container 210. Container 210 may be any type of container used to contain the components of an electrochemical cell. In some embodiments, container 210 may be a sealed can (container 210), such as a steel/metallic can, or pouch (pouch container 710 shown in FIG. 7), such as a thin-walled, flexible bag made of a polymer, metal, or composite material such as conventional metal/polymer [multi] laminates or other chemically and electrochemically compatible polymer material/composite.

Container 210 houses a cell stack 215 (as shown in FIG. 6). Cell stack 215 may be any type of cell stack known in the art and typically includes conductive electrodes, such as an anode and a cathode, and one or more non-conductive separator layers. The electrodes may have any configuration known in the art, such as a film, a plate, a rod, tube, cylinder, bobbin, or the like. In some embodiments, cell stack 215 may include layers of cathode and anode material and separator layers. Such a cell stack construction is shown schematically in FIG. 6, with a single cell including a cathode layer 640, an anode layer 650, and a separator layer 660. As is well known in the art, while only three layers are shown, multiple separator layers 660 may be included for a single cell, and multiples of these single cells may be provided to form a cell stack 215.

Cathode layer 640 may be any type of cathode material known in the art. In some embodiments, cathode layer 640 may be selected from the following materials: LiCoO2, LiNiO2, LI(NixMnyCoz)O2, other lithium-manganese oxides, Li(NixCoyAlz)O2, lithium-ion phosphate, FeS2, V2O5, electrically conducting polymers, cathodes for non-lithium-based cell as will be known to those in the art, and/or a blend of these or other known materials.

Anode layer 650 may be any type of anode material known in the art. In some embodiments, anode layer 650 may be selected from the following materials: electrochemically active graphites such as meso-carbon micro bead (MCMB), hard carbon, other forms of natural or artificial graphite, graphitic carbon, amorphous carbons, graphene, silicon, alloys containing transition elements and/or Sn, Bi, Ge, etc., and active metals (i.e., lithium, sodium), metal oxides such as lithium titanium oxide, and lithium metal oxides/nitrides, tin-based alloys, silicon-based materials, materials for non-lithium-based cells as will be known to those in the art, and/or a blend of these or other known materials.

Separator layer 660 may be any type of separator known in the art, such as a gelatinous microporous membrane configured to block physical contact between cathode layer 640 and anode layer 650 to prevent short-circuiting of the electrodes while allowing the diffusion of ions through separator layer 660. In some embodiments, a porous polymer membrane such as Celgard® may act as separator layer 660.

In some embodiments, container 210 may be hermetically sealed so that container 210 is airtight to prevent the ingress of oxygen, moisture, and any external contaminants from entering into the interior of container 210 or loss of electrolyte from container 210. In other embodiments, electrochemical cell 200 and/or container 210 may include seals (not shown) that are not hermetic but are semi-hermetic so that the container is nearly airtight or airtight for known periods of time. In other embodiments, the seals may not be airtight but may be sufficient to contain the electrolyte within cell 200 and/or container 210 and prevent invasion of air, moisture, and/or contaminants into cell 200 and/or container 210 for a desired period of time.

In some embodiments, container 210 may include access for introducing container 210 with an electrolyte so that the remaining seals of container 210 may remain intact throughout the filling and extraction processes. In some embodiments, container 210 may include access such as a fill tube 220. Fill tube 220 may extend through at least one wall of container 210 to provide access to an interior of container 210 from the exterior environment. Fill tube 220 may be any size or shape to allow for the introduction and extraction of electrolyte and/or as-formed gases into and from the interior of container 210. Fill tube 220 may be made from any material that is capable of being associated with container 210 and is generally non-reactive to any electrolyte or other active component of electrochemical cell 200. Fill tube 220 may include various optional structures to allow for ease of introduction and extraction of electrolyte to electrochemical cell 200 and/or container 210, such as elastomeric ports that can accommodate and seal to multiple types of injection/extraction structures, a tapered nozzle 322 in the interior of container 210 to allow for rapid dispersion or extraction of an electrolyte throughout the interior of container 210, a porous portion (not shown) within interior of container 210 to allow for controlled dispersion or extraction of electrolyte to or from container 210, and/or interior channels (not shown) within container 210 to further control the dispersion or extraction of an electrolyte to or from container 210.

Thus, in an embodiment of the method that uses an access such as fill tube 220, first electrolyte step 110 includes associating a first electrolyte reservoir such as first electrolyte reservoir 310 containing a first electrolyte 300 shown in FIG. 3 with fill tube 220. First electrolyte reservoir 310 may be any type of receptacle known in the art capable of containing and dispensing an electrolyte. In some embodiments, first electrolyte reservoir 310 may be a bag, box, jug, pouch, bottle, hopper, syringe barrel, can, container, beaker, or other similar receptacle. Associating first electrolyte reservoir 310 with fill tube 220 may include attaching a connector, such as first connecting tube 320, to fill tube 220 so that a pump (not shown) may introduce first electrolyte 300 into fill tube 220 in a fill flow direction 324. As will be recognized by those of skill in the art, the association of first electrolyte reservoir 310 with fill tube 220 will depend on the type of reservoir provided and the method of introducing the flow of first electrolyte 300 into fill tube 220. Such adaptations will be readily recognized by those in the art. In other examples, for example, associating first electrolyte reservoir 310 with fill tube 220 may include positioning first electrolyte reservoir 310 in proximity to fill tube 220 to essentially spill first electrolyte 300 into fill tube 220. In yet other examples, associating first electrolyte reservoir 310 with fill tube 220 may include inserting a needle of a syringe into fill tube 220 so that depressing a plunger of the syringe may introduce first electrolyte 300 into fill tube 220. In yet other examples, associating first electrolyte reservoir 310 with fill tube 220 may include inserting a nozzle of a pouch into fill tube 220 so that squeezing the pouch may introduce first electrolyte 300 into fill tube 220. The rate of introduction of first electrolyte 300 may be selected and controlled to allow for accurate measurement of the amount of first electrolyte 300 introduced into container 210 and/or to ensure that no cell components are physically moved or dislodged, which may cause a short.

In some examples, access to fill tube 220 may include the step of unsealing fill tube 220. For example, unsealing fill tube 220 may include puncturing or breaking a permanent seal, uncrimping an opening of fill tube 220, and/or opening a temporary seal by removing a cap or press-fitted portion. Those of skill in the art will recognize the type of seal used for fill tube 220 and will recognize how to create access to fill tube 220.

When an access such as fill tube 220 is not provided, first electrolyte step 110 may include opening container 210 using any method known in the art, such as puncturing or breaking a permanent seal, removing a wall or portion of a wall of container 210, or opening a temporary seal of container 210 by removing a cap or press-fitted portion. Those of skill in the art will recognize the type of seal used for container 210 and will recognize how to create access to container 210.

First electrolyte 300 may be selected from any type of electrolyte known in the art that can be introduced and extracted from an electrochemical cell, such as liquid, gel, gas (at ambient temperature and pressure) or solid electrolyte. Liquid electrolytes, either aqueous or non-aqueous, may be particularly suitable for use in the present method such as method 100 or method 150. Gel electrolytes may require heating to be able to perform the desired introduction and extraction steps of the present methods. Solid electrolytes may require a larger opening for introduction and extraction, such as a hinged casing with high-grade elastomeric seals and temporary fasteners or cutting open container 220 and re-sealing by welding or other methods known in the art, to allow for introduction and extraction into cell 200. Additionally, for gel and solid electrolyte processes, a primary (liquid, gas, gel, or solid) electrolyte may be added to perform the initial activation of the cell 200 and to form necessary interfacial layer(s) that will enable beneficial processes such as facilitating intimate contact with the secondary gel/solid electrolyte, or form a stable EEI that would otherwise limit the specific composition of the gel/solid electrolyte, and/or improve manufacturing processes such as wetting of the electrode. Solid electrolytes may be utilized as a composite within the electrodes themselves, requiring appropriate processing steps at their interfaces as would be known by those in the art.

First electrolyte 300 may be selected to have a composition that will produce the desired surface EEI on the electrodes, such as cathode EEI 642 and anode EEI 652 shown in FIG. 6. First electrolyte 300 may be selected to provide an EEI that will optimize performance of electrochemical cell 200 in extreme conditions, such as operation and storage in extreme temperatures, such as temperatures greater than about 60 degrees Celsius in some examples, above about 40 degrees Celsius in some examples, below about zero (0) degrees Celsius in some examples, or below about minus 20 degrees Celsius in some examples, high currents and/or voltages, large discharge depths, rapid charge/discharge cycling, extended storage shelf-life, and/or reduced self-discharge. First electrolyte 300 may be selected to provide an EEI that will allow for refurbishment of cell 200 after the useful life of cell 200 has been expended. First electrolyte 300 may be selected from the following materials: ionic liquids containing imidazolium, pyrrolidinum, piperdinium, and ammonium, carbonate solvents, and/or blends of these materials, and, optionally one or more additives such as ethyl propionate, prolyl propionate, fluoroethylene carbonate, vinyl carbonate, propane sultone, hexanedinitrile, lithium bis(oxalate)borate, and adiponitrile, and one or more appropriate conducting salts (i.e., LiPF6, LiBF4, LiClO4, LiAsF6, LiTFSI, and other conducting salts as will be known in the art) in proportions/concentrations formulated to address specific desired performance, as will be discernible to those in the art. Once introduced into electrochemical cell 200 via tapered nozzle 322 in introduction direction 326, first electrolyte 300 will come into contact with the electrodes, such as cathode 640 and anode 650 as shown in FIG. 6 as described and discussed above. First electrolyte 300 may substantially surround the electrodes or may only partially contact one or both electrodes when introduced into the electrochemical cell 200.

After filling electrochemical cell 200 with first electrolyte 300, access to the interior of container 210 can be sealed. For example, fill tube 220 may be crimped, welded, capped, or otherwise permanently or temporarily sealed. The seal may be hermetic, semi-hermetic, or not hermetic.

First electrolyte 300 may be provided in a specialized container (not shown) that may not be part of a stand-alone electrochemical cell. For example, the specialized container may be part of a bath in a manufacturing process that does not contain structures for ongoing electricity generation such as a cell stack, but does contain the structures capable of electrochemically activating first electrolyte 300 so that the desired surface EEI may be formed on the electrode(s) inserted into the specialized container. This specialized container may be reusable, such as in a manufacturing setting, so that the electrode(s) may be removed from the specialized container after the desired surface EEI has been formed and then transferred to another site, facility, or storage location for incorporation into a stand-alone electrochemical cell. Another electrode or electrodes may then be placed into the specialized container for EEI development. In this way, extraction of the first electrolyte 300 need not occur for each electrochemical cell in production.

The desired surface EEI is formed upon electrochemical activation of the electrochemical cell such as electrochemical cell 200. In methods 100 and 150, this initial electrochemical activation occurs in first activation step 120. Activation is considered herein to include all electrical, temperature, and physical handling steps performed during the final stages or near to the final stages of assembly of an electrochemical cell or in the refurbishment of an electrochemical cell, while electrochemical activation is the step in the process of activation of the electrochemical cell where a voltage or current is drawn or applied to the electrochemical cell 200. During a typical electrochemical activation process, the electrochemical cell 200 is subjected to both constant voltages and high and low currents (charge and discharge). Optionally, the electrochemical cell 200 may be subjected to temperature cycles in one or more additional, non-electrochemical activation step(s). The activation and electrochemical activation steps are well-known in the art, and any variations in temperature, voltage, duration, etc., to achieve desirable EEI characteristics through a reaction of an electrolyte with the electrode(s) will be discernable to those in the art.

The electrochemical activation of the cell in the present methods may include charging the electrochemical cell 200 to a first voltage cutoff at a predetermined temperature and time to trigger the electrochemical decomposition of first electrolyte 300. This decomposition may include various components of first electrolyte 300, such as salts, solvents, and additives. Any combination of the salts, solvents, and/or additives may be selected to produce a unique EEI with specific properties. For example, the unique EEI may be formed to optimize performance characteristics at high temperatures, so that a replacement electrolyte may function efficiently at lower operational temperatures as well as operative efficiently at high temperatures. In other examples, the EEI may be formed to optimize performance at high currents and/or voltages, large discharge depths, rapid charge/discharge cycling, to achieve extended storage shelf-life, and/or reduced self-discharge. In still other examples, the unique EEI may be formed to allow for refurbishment and efficient use at the end of the life cycle of the electrochemical cell with the original electrolyte, where a replacement electrolyte still efficiently accesses the electrodes using the EEI despite apparent passivation or degradations of the electrode(s) by the original electrolyte.

In some examples, the EEI may be similar to cathode EEI 642 and anode EEI 652 shown in FIG. 6, fully formed on layers on the surface of cathode layer 640 and anode layer 650, respectively. However, the EEI may be patchier, with some portions of the electrodes being covered by the EEI while other portions of the electrodes are bare, i.e., retain the original surface composition and characteristics of the electrode(s). The EEI may be layers of substantially consistent thickness, such as that of cathode EEI 642 with cathode EEI thickness 644 and anode EEI 652 with anode thickness 654. However, the thickness of the EEI may vary over the surface of the electrodes. In some examples, only one type of electrode—either the cathode or the anode—will develop the desired EEI. As will be recognized by those in the art, the amount of electrochemical decomposition of the first electrolyte 300 to form the EEI may be controlled by varying such factors as the voltage applied (in some embodiments, to include the full cell voltage window, for example, from 0.5 to 2.0 V, while other examples with other ranges for the full cell voltage window are also contemplated), the time duration of the applied voltage (in some embodiments ranging from 1 min-24 hours), the temperature of the electrochemical activation, the specific formulation of the first electrolyte, the specific formulations of the electrodes, and other factors as would be known to those in the art.

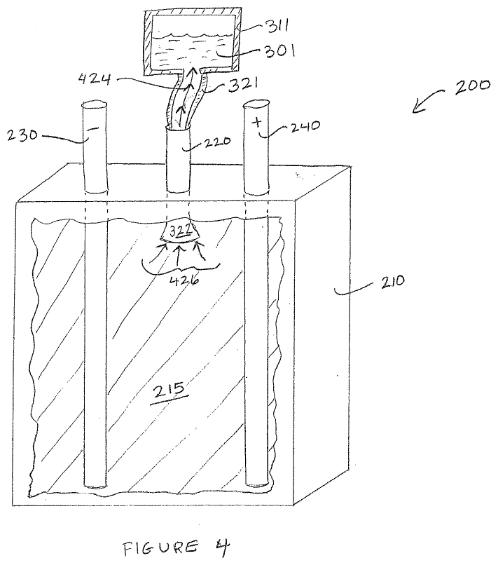

Once the desired EEI is formed, the remaining first electrolyte 301 is at least partially extracted from the electrochemical cell 210 in extraction step 130 as illustrated in FIG. 4. This step is essentially the inverse of first electrolyte step 110. Here, a second reservoir 311 may be associated with fill tube 220. Second reservoir 311 may be any type of reservoir discussed above with respect to first reservoir 310 and may be the same as or different from first reservoir 310. Second reservoir 311 may be associated with fill tube 220 or electrochemical cell 200 using any method, technique, or structure as discussed above with respect to the association of first reservoir 310 with fill tube 220 or electrochemical cell 200.

In some embodiments with liquid electrolytes or flowable gel electrolytes, to extract the remaining first electrolyte 301, which may be compositionally different from first electrolyte 300 due to the decomposition process and the possible presence of as-formed gas, remaining first electrolyte 301 is drawn away from cell stack 215, into tapered nozzle 322 in extraction direction 426, and into fill tube 220. One or more electrolytes may be composed of pressurized gas phases with or without conducting salts in which extraction/filling processes are controlled by appropriate equipment and hardware not specifically described here. A preliminary step of unsealing fill tube 220 or container 210 may first be performed. The unsealing of fill tube 220 or container 210 may be accomplished using any method discussed above with respect to unsealing any portion of electrochemical cell 200.

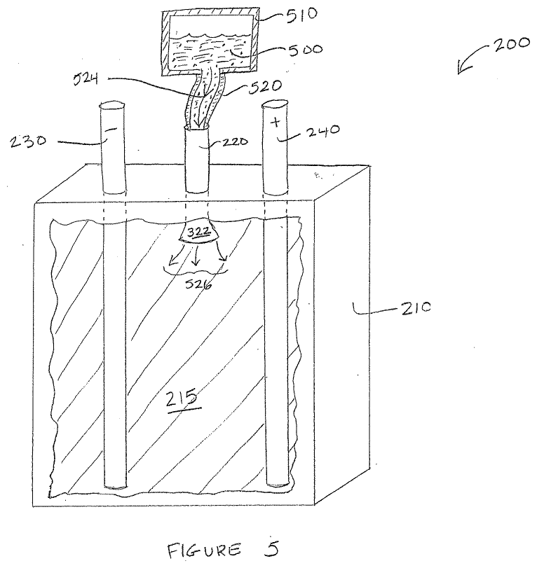

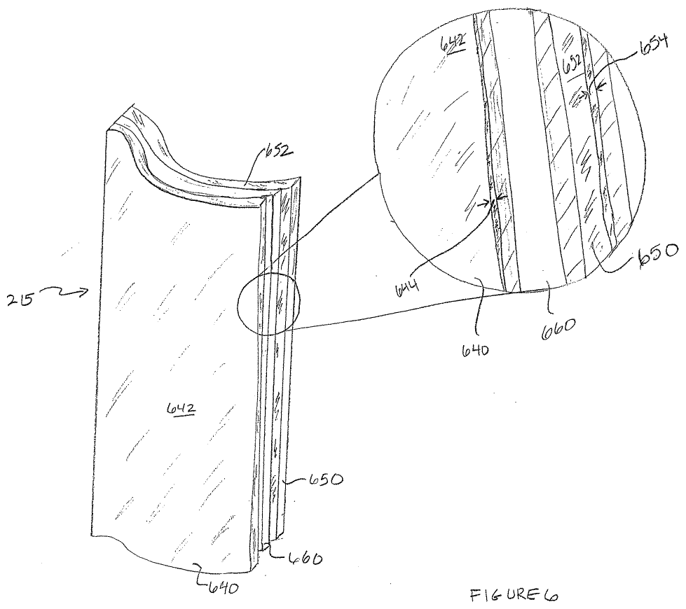

Once extraction begins, at least a portion of remaining first electrolyte 301, and in some examples, all or substantially all of remaining first electrolyte 301 flows through fill tube 220 in extraction flow direction 424. At least a portion of remaining first electrolyte 301 is then drawn into and collected in second reservoir 311 for reuse or other disposition. A portion of remaining electrolyte 301 may be allowed to remain for mixture with a second electrolyte such as second electrolyte 500 shown in FIG. 5. Here, the extraction of at least a portion remaining first electrolyte 301 may occur by reversing the method of introducing first electrolyte 300 into fill tube 220 or container 210. For example, if a pump is used in first electrolyte step 110, then extraction step 130 includes reversing the action of the pump. Similarly, if depressing a syringe is used in first electrolyte step 110, then extraction step 130 includes pulling a vacuum in the syringe barrel to extract remaining first electrolyte 301 from fill tube 220 or container 210. Alternatively, if step 110 included pouring or spilling first electrolyte 300 into fill tube or container 210, then extraction step 130 could include pouring or spilling remaining first electrolyte 301 into second reservoir 311. Where multiple electrolyte activation is intended for solid state and/or other gel-type electrolytes that are particularly difficult to extract, the initial activation process may occur in a specialized container such as an electrolyte bath or other temporary container where activation of the cell stack is possible and final assembly of the cell stack with either a solid-state or gel-type electrolyte cell stack occurs by movement of the cell stack into the final container with necessary sealing procedure(s).

To optimize the performance of or to refurbish electrochemical cell 200, a second electrolyte, such as second electrolyte 500 shown in FIG. 5, is introduced into cell 200 in exemplary second electrolyte step 140. Similar to first electrolyte 300, second electrolyte 500 may be selected from any type of electrolyte known in the art that can be introduced into and extracted from an electrochemical cell, such as liquid, gel, or solid electrolyte. When a solid or gel electrolyte is utilized, a primary or secondary liquid and/or gaseous electrolyte may be used such as to improve overall characteristics such as those pertaining to performance or manufacturing ease (i.e., in some embodiments, wetting, interfacial contact, ion transport, and others as would be recognized by those in the art). Second electrolyte 500, however, has a different composition from first electrolyte 200. The difference may be relatively minor, such as different salts, concentrations, solvents, solvent ratios, additives, combinations of these differences, or other differences as will be recognized by those in the art.

Second electrolyte 500 may be selected to have a composition that interacts with the deposited EEI on the electrodes, such as cathode EEI 642 and anode EEI 652 shown in FIG. 6, in order to achieve desired optimized performance characteristics or to function efficiently after passivation of the electrodes over the first life of electrochemical cell 200. Second electrolyte 500 may or may not be selected to interact with the deposited EEI to optimize performance of cell 200 in extreme conditions, such as operation and storage in extreme temperatures, such as temperatures greater than about 60 degrees Celsius in some examples, above about 40 degrees Celsius in some examples, below about zero (0) degrees Celsius in some examples, or below about minus 20 degrees Celsius in some examples, high currents and/or voltages, large discharge depths, extended storage shelf-life, and/or reduced self-discharge. Second electrolyte 500 may be selected to interact with the deposited EEI to allow for refurbishment of cell 200 after the useful life of cell 200 has been expended. Second electrolyte 500 may be selected from the following materials: LiPF6, LiBF4, LiCLO4, LiCF3SO4, LiAsF6, diethylcarbonate, ethy-methylcarbonate, propylcarbonate, ethylene carbonate, LiDFOB, LiBOB, LiTFSi, blends of these materials, and, optionally one or more additives such as ethyl propionate, prolyl propionate, fluoroethylene carbonate, vinyl carbonate, propane sultone, hexanedinitrile, and adiponitrile.

Once the desired second electrolyte 500 is selected to match the desired properties provided by the unique EEI formed from the decomposition of first electrolyte 300, second electrolyte 500 is introduced into electrochemical cell 200 in second electrolyte step 140 as illustrated in FIG. 5. This step is essentially the same as first electrolyte step 110 albeit with the compositionally different second electrolyte 500. Where solid or gel electrolytes are utilized, specific differences in the extraction and activations processes may differ as described above or otherwise known by those in the art. Here, a third reservoir 510 is associated with fill tube 220. Third reservoir 510 may be any type of reservoir discussed above with respect to first reservoir 310 and may be the same as or different from first reservoir 310. Third reservoir 510 may be associated with fill tube 220 or container 210 using any method, technique, or structure as discussed above with respect to the association of first reservoir 310 with fill tube 220 or container 210. Once a sufficient amount of second electrolyte 500 has been introduced into container 210, access to container 210 is sealed or re-sealed using any sealing method discussed above with respect to the sealing after the introduction of first electrolyte 300 into container 210. The rate of introduction of second electrolyte 310 may be selected and controlled to allow for accurate measurement of the amount of second electrolyte 310 introduced into container 210 and/or to ensure that no cell components are physically moved or dislodged, which may cause a short.

To complete this multi-electrolyte activation process, such as method 100, a second electrochemical activation step 160 of electrochemical cell 200 is performed. Second electrochemical activation step 160 is similar to first electrochemical activation step 120 discussed above. As will be recognized by those of skill in the art, the voltage, temperature, and duration of second electrochemical activation step 160 may differ from that of first electrochemical activation step 120 due to the different compositions of first electrolyte 300 and second electrolyte 500 as well as potentially desiring a different end result. For example, first electrochemical activation step 120 may be used to optimize a performance characteristic of electrochemical cell 200 by creating the unique EEI. As such, first electrochemical activation step 120 may be of a minimum acceptable duration so as to achieve sufficient build-up of the decomposition materials onto the electrodes. For second electrochemical activation step 160, however, the duration may be significantly shorter because the intention is not to create a unique EEI layer but simply to activate the electrochemical cell 200.

Electrochemical cell 200 with the unique EEI formed by the decomposition of first electrolyte 300 onto the electrodes may have optimized performance over the use of just first electrolyte 300 or second electrolyte 500. For example, first electrolyte 300 may have efficient performance for high temperatures, such as temperatures in excess of 45 degrees Celsius. However, first electrolyte 300 may have poor performance at lower temperatures, such as at room temperature and below. Second electrolyte 500 may have good performance at a wide range of typical use temperatures, such as −20 to 60 degrees Celsius, but poor performance with regard to voltage/temperature stability that is otherwise mitigated by the EEI formed by first electrolyte 300. By creating the EEI using the decomposition of first electrolyte 300, second electrolyte 500 can take on some of the performance properties of first electrolyte 300 and may have good performance beyond that of either electrolyte composition alone.

As will be recognized by those in the art, multiple iterations of method 100 or other exemplary embodiments of the present method may occur. For example, as shown in FIG. 1A, after the second electrochemical activation in step 160, in method 150, the method shown in FIG. 1 then loops back to extraction step 130, where second electrolyte 500 may be extracted from cell 200 in a manner similar to the extraction of first electrolyte 300 as discussed above. A third electrolyte (not shown), compositionally different from the first and second electrolytes, may then be introduced to the electrochemical cell 200 and activated. This process may be repeated for as many electrolyte compositions as may yield the desired results with the unique EEI layer or layers formed on the electrodes. Similarly, this process can be used to refurbish electrochemical cell 200 at the end of the useful life of the second electrolyte as any times as the electrochemical cell 200 will continue to operate efficiently with new electrolytes.

Other devices and methods for introducing electrolytes into the electrochemical cell are contemplated herein. As illustrated in FIG. 7, a pouch container 710, having many of the same structures as in a can-type embodiment such as container 210 can be provided, having a pouch cell stack 715, similar to cell stack 215 discussed above, that is associated with a pouch negative lead 730 and a pouch positive lead 740, similar to negative lead 230 and positive lead 240 discussed above. Pouch container 710 may include multiple seals to provide additional hermetic/semi-hermetic and/or structural support for pouch container 710. For example, pouch container 710 may include an internal seal 714, an external seal 712, and a second external seal 713. External seal 712 and/or second external seal 713 may include a folded portion of the pouch material so that pouch container is more rigid along those edges. Also similar to container 210, pouch container 710 may include an access port 720 similar to fill tube 220 to facilitate introduction and extraction of electrolyte(s) to and from pouch container 710. Instead of providing an additional structure such as a tube, a guided opening through the walls of pouch container 710 may be provided. This guided opening may be formed by selectively joining portions of the walls of pouch container 710 to form a passage into the interior of pouch container 710. The selective joining may be achieved using any method known in the art, such as with adhesives or by welding. The size and shape of the guided opening may be selected to receive a nozzle, funnel, needle, or other structure configured to transfer electrolyte from a reservoir into pouch container 710.

As will be recognized by those in the art, the electrodes themselves have been optimized for a particular use, such as storage and/or operation at extreme temperatures and/or pressures, or extreme usage conditions such as rapid charge/discharge cycling and/or subjecting an electrochemical cell to large discharge depths, by providing the electrodes with a unique EEI. These unique electrodes and EEIs could have any of the characteristics discussed above with respect to electrode type, EEI type, the amount of coverage of the EEI only the electrode (i.e., complete coverage or patches of EEI formed on the electrode surface), and the thickness of the EEI on the electrode. As such, the unique EEI electrodes themselves may, in an initial use and/or refurbishment situation, be transferred from a first container to another container where the first container may or may not be part of a stand-alone electrochemical cell. Unique EE electrodes may also be provided separately from the rest of the structure of the end-use electrochemical cell. For example, the unique EEI electrodes may be manufactured in one facility or part of a facility and then provided to another facility or other part of a facility for incorporation into an electrochemical cell.

The methods and techniques discussed above may be used with any type of cell including dry cells, which are typically manufactured in tightly controlled environments, such as clean rooms with very low humidity (in some embodiments a dry room or dry box) and tight temperature controls. Therefore, it is anticipated that in many cases, even when the electrochemical cell is a dry cell, this method would be performed during the initial manufacture of an electrochemical cell such as electrochemical cell 200 for the multi-electrolyte activation/optimization of performance characteristics or that electrochemical cell 200 would be returned to a manufacturing site for refurbishment. However, in certain industries such as the oil and gas industry or military, the industries will have access to appropriate manufacturing spaces and skilled personnel to be able to perform these methods. In these cases, a kit with any special tools required to unseal electrochemical cell 200, appropriate electrolytes with or without reservoirs such as reservoir 310 or 510, parts to associate the electrolyte reservoirs to electrochemical cell 200, unique EEI electrodes, and/or instructions for how to perform the method may be provided, either with the initial purchase of the electrochemical cell or as a stand-alone purchase.

Experimental Results for High Temperature Electrochemical Cells

Various tests were performed using embodiments of a multi-step activation method according to the methods discussed herein, such as method 100. While discussed in terms of method 100, other similar methods or embodiments are equally applicable to this testing procedure. In this testing procedure, three groups of cells with a pouch construction, similar to the pouch shown in FIG. 6, were tested with liquid electrolytes:
Group A (control with standard electrolyte): Standard Carbonate Electrolyte (1.2M LiPF₆ EC/EMC (30/70), (EC—Ethylene Carbonate and EMC—Ethyl Methyl Carbonate);
Group B (multi-stage electrolyte—standard carbonate electrolyte (same as Group A) activation then replacement and activation with PMP (in this example N-propyl-N-methylpyrrolidinium) ionic liquid for high temperature stability; and
Group C (control): Activate with PMP (in this example N-propyl-N-methylpyrrolidinium) ionic liquid.

For cells in Groups A and B, the first electrolyte for step 110, filling the cell with a first electrolyte, includes a combination of traditional Li-Ion battery electrolyte (containing LiPF₆ salt dissolved in a mixture of carbonate-based solvents to form a good EEI layer) and ionic liquid-based electrolyte (to improve high-temperature stability) in a LiCoO₂/graphite-based pouch cell with a capacity of 170 mAh were provided. Group C had a similar structure, but was filled with a PMP-based ionic liquid. A commercial polyethylene-based separator was used to separate the LCO (LiCoO₂) based positive electrode and the graphite based negative electrode.

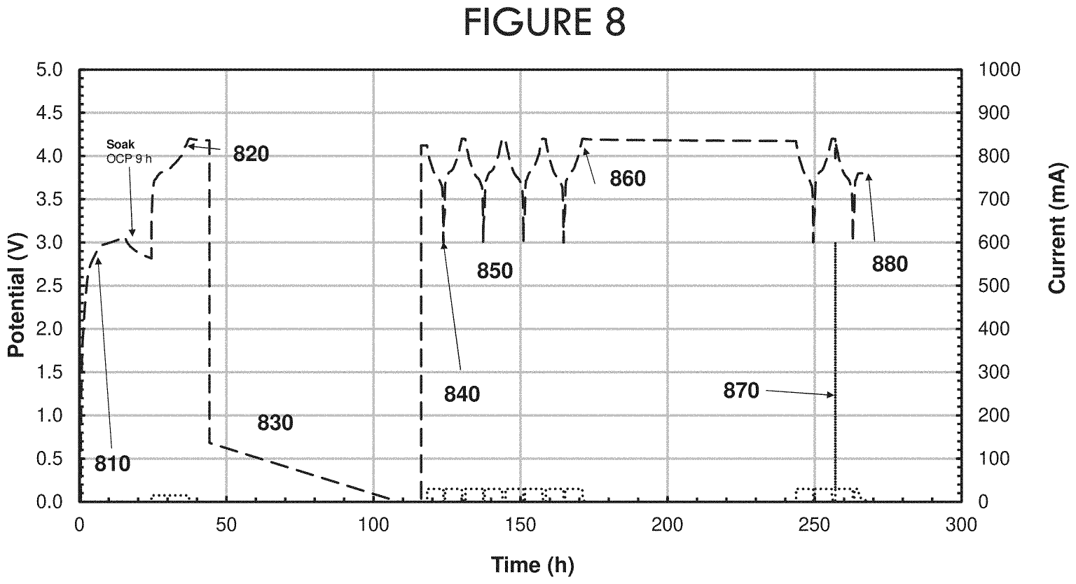

All cells were activated using a multi-stage activation procedure, shown in FIG. 8. The first stage of activation, in steps 810 to 840, forms the EEI on the electrodes. The cells were first charged at an initial charge step 810 with 0.25 mA for 15 h and held at 3.0 V for 9 h. At first full charge step 820, the cell is again charged to 4.2 V with 15 mA. At soak step 830, the cells were then placed in a 50° C. temperature chamber for 72 h. After the 72 h period, at first discharge and electrolyte replacement step 840, the cells were discharged at 24° C. using 30 mA to 3.0 V. The cells were then removed from the cycler.

The first electrolyte was then replaced with a second electrolyte that will operate in extreme temperatures and activated in a second stage in steps 850 to 880, similar to the methods discussed herein such as method 100. The first electrolyte was extracted along with any formed gases and a second electrolyte was introduced into the pouch. In the first group of cells, Group A, cells were opened by trimming on side of the pouch seal in a dry room (dew point −30° C. or better). The trimming allowed for release of gas (if any) that formed during the initial conditioning under vacuum, then refilled with standard Li-Ion battery electrolyte with a formulation of 1.2M LiPF₆ EC/EMC (30/70), (EC—Ethylene Carbonate and EMC—Ethyl Methyl Carbonate). The pouch was then resealed to continue the activation process shown in FIG. 8.

In the second group of cells, Group B, the cells, in a dry room (dew point −30° C. or better), Group B cells were opened by trimming the side of the pouch seal. The inside of the pouch was rinsed with 4 mL of EMC and vacuum dried. After vacuum drying, 0.7 mL of ionic liquid-based electrolyte was added to the pouch, and the cells were resealed under vacuum and the conditioning steps were continued.

In the third group of cells, Group C, the cells were trimmed on the side of the pouch seal in a dry room (dew point −30° C. or better). The trimming allowed for release of gas (if any) that formed during the initial conditioning under vacuum, then refilled with a PMP based ionic liquid. The pouch was then resealed to continue the activation process shown in FIG. 8.

All groups of cells were cycled three more times at 30 mA for both charge and discharge to stabilize the cell capacity in stabilization step 850. Next, in self-discharge step 860, all cells were charged to 4.2V at 30 mA and rested for 72 h to measure the self-discharge voltage loss, and followed by a discharge at 30 mA to 3.0 V. On the final cycle, in resistance step 870, all cells were charged to 4.2 V at 30 mA and discharged to 3.0 V at 30 mA with 10%, 50%, and 100% depth-of-discharge (DOD) with 600 mA for 100 ms pulse to calculate cell resistance at different DOD. In a half-charge step 880, all cells were charged to 3.8 V at 30 mA and discharged to 1.5 mA. The Group C cells were swollen (showed gassing) after the conditioning process was completed and were removed from further testing.

Results

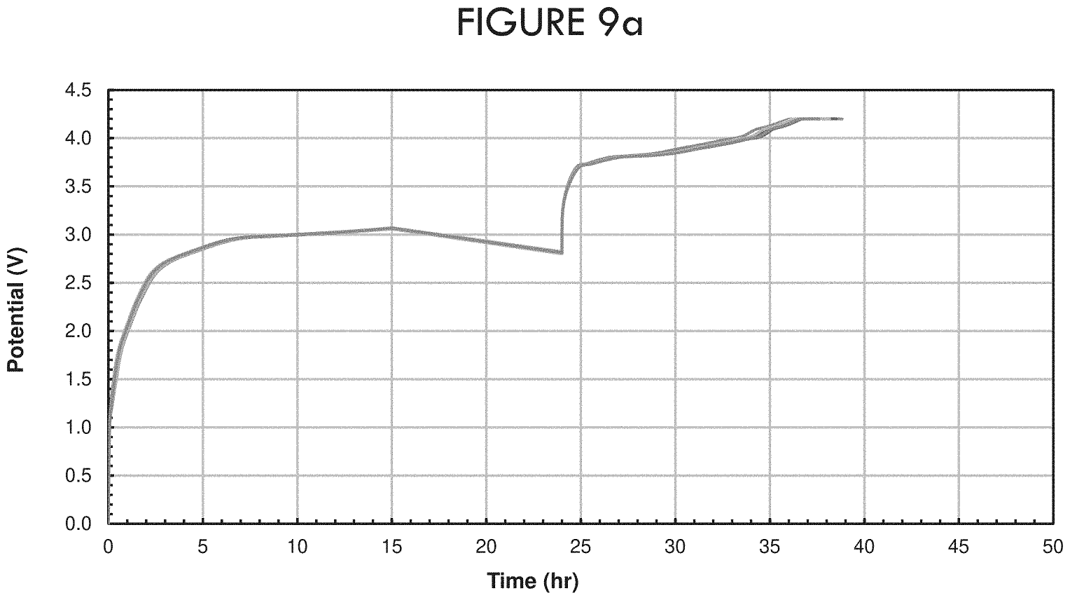

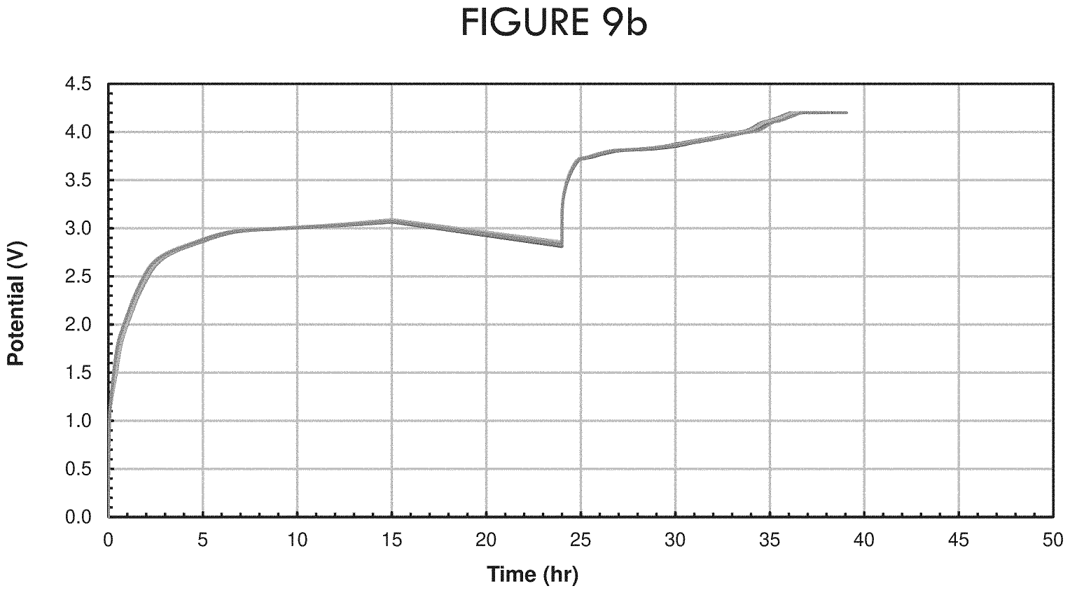

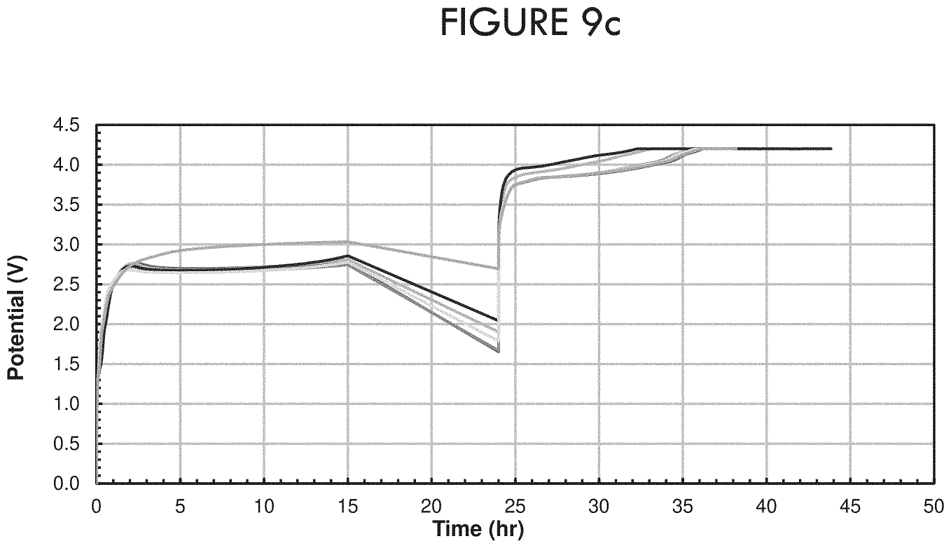

Various measures of the cells were taken during the testing procedure. For each group of cells, Groups A-C, a first charge voltage profile during the first charge from step 810 to 820 were taken and shown in FIGS. 9a-c. The Group A first charge voltage profile is shown in FIG. 9a, the Group B first charge voltage profile is shown in FIG. 9b, and the Group C first charge voltage profile is shown in FIG. 9c. Notably, Groups A and B had good first charge voltage, but Group C cells show less consistent results. While not wishing to be bound by any theory of operation, the Group C issues are possibly due to wetting or EEI formation issues. As a final note, the group C cells showed very high internal cell resistance (˜6000 ohms) upon activation due, possibly, to the difficulty of wetting of ionic liquid within the electrode structure. This supports the premise that the standard electrolyte during the original activation step assists in the overall performance of the battery by forming a good EEI. Group C cells were placed in a temperature chamber at 38° C. for 2 h, and subsequently, the resistance of these cells dropped and was similar to that of groups A to B (80-100 milliohms).

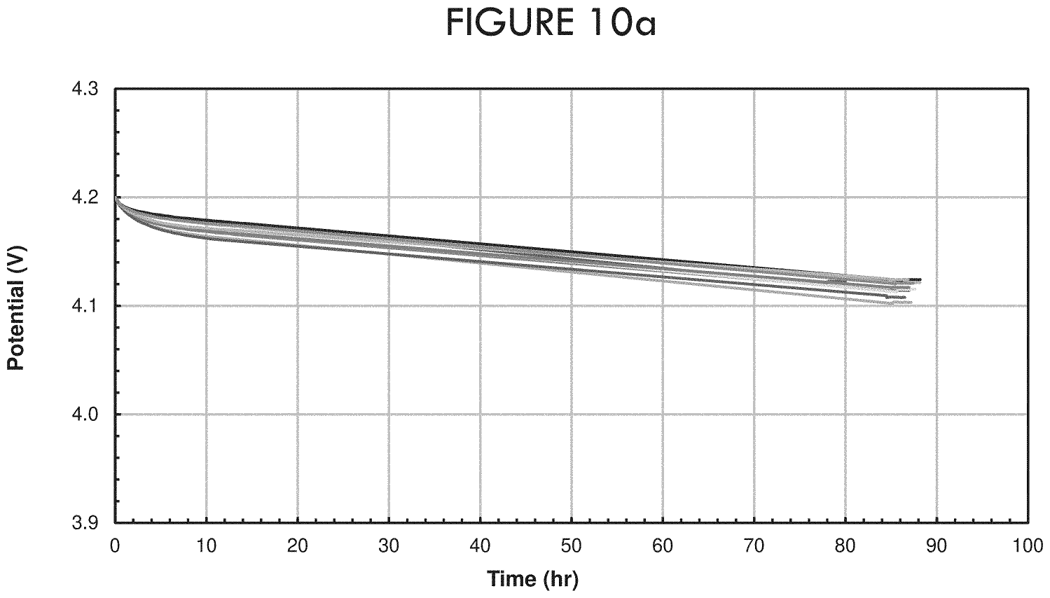

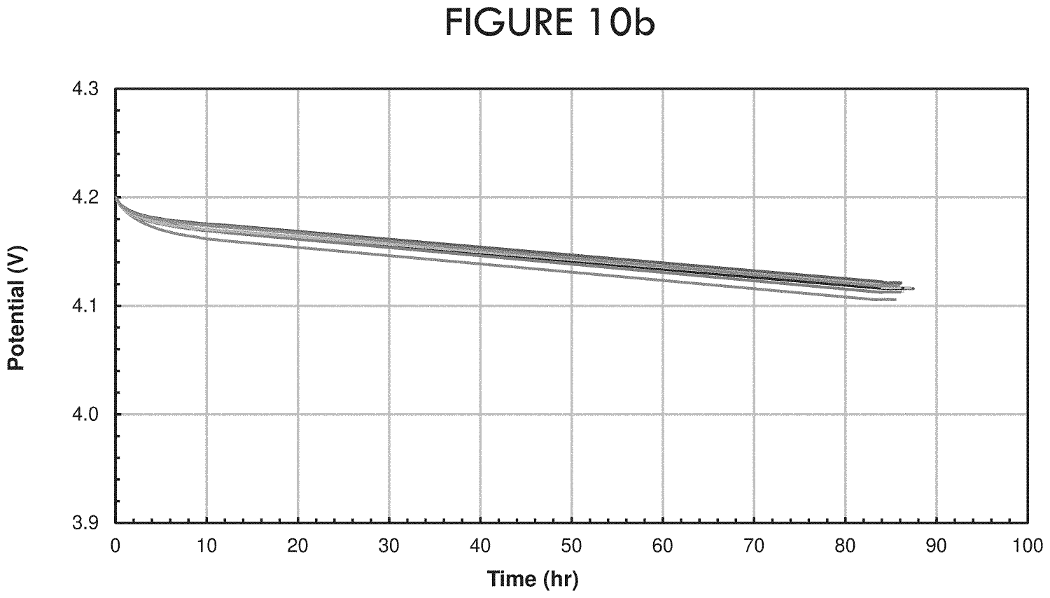

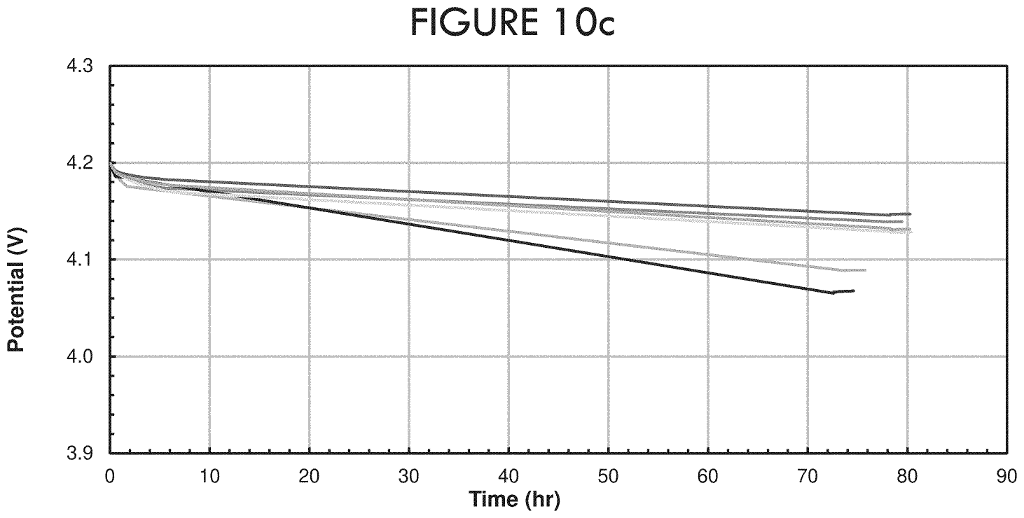

At soak step 830, the 50 degree Celsius soak potentials were measured. The Group A 50 degree Celsius soak potential is shown in FIG. 10a, the Group B 50 degree Celsius soak potential is shown in FIG. 10b, and the Group C 50 degree Celsius soak potential is shown in FIG. 10c. Again, Groups A and B show stable results while the Group C results show stability issues. While not wishing to be bound by any particular theory of operation, the Group C issues may be due to wetting or EEI formation issues.

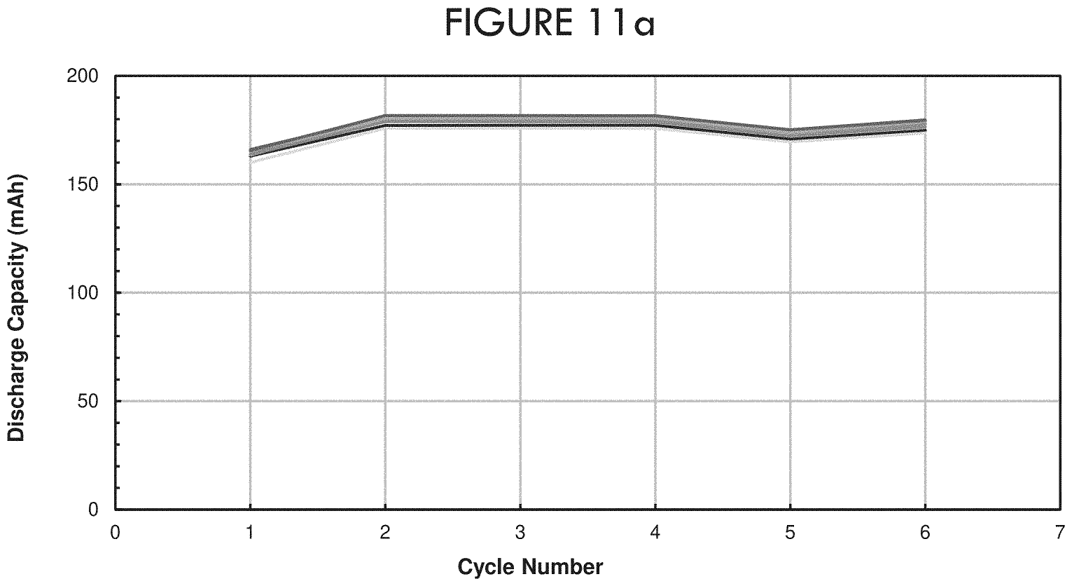

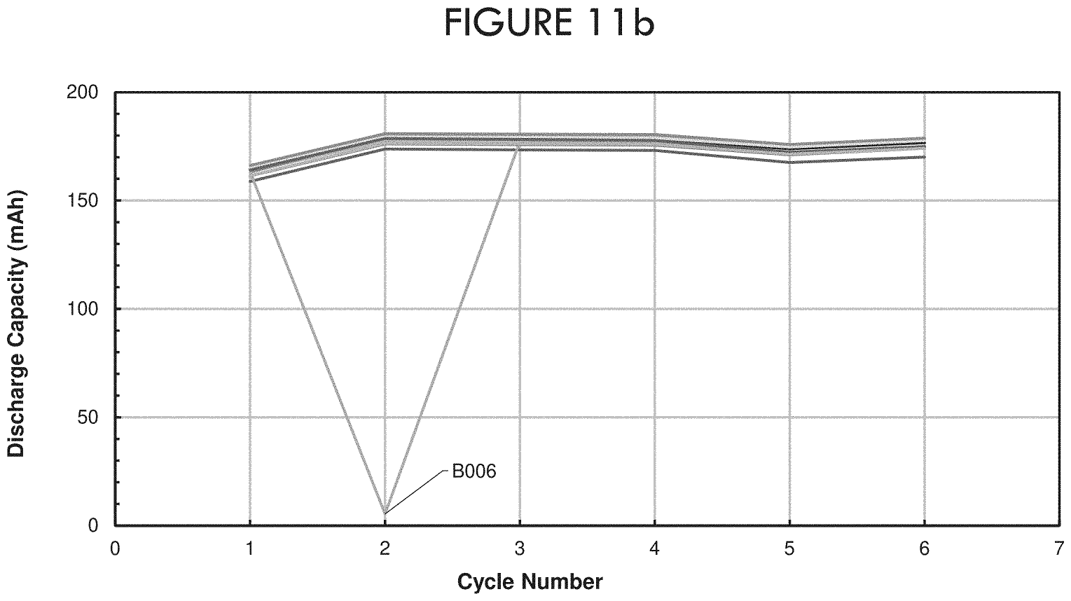

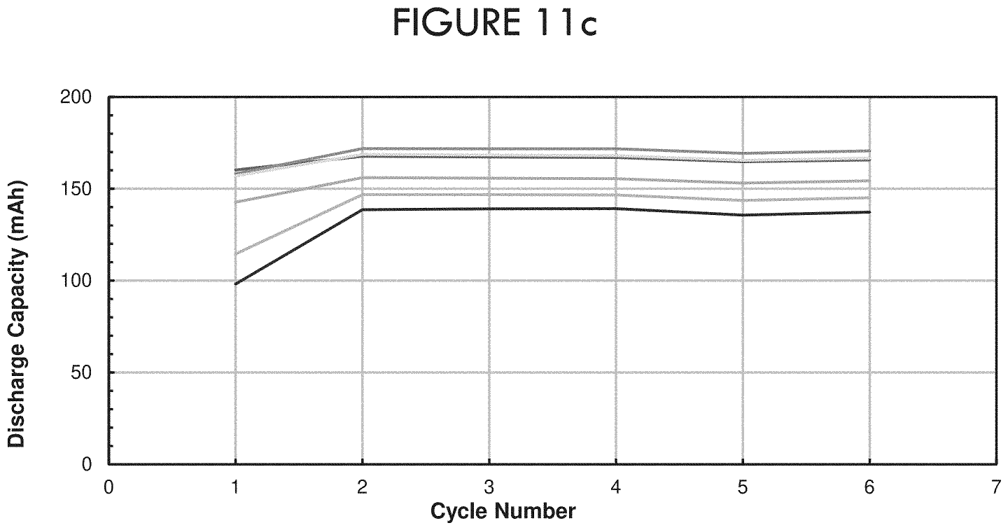

At stabilization step 850, the discharge capacity of the cells were measured for each of the groups. The Group A discharge capacity is shown in FIG. 11a, the Group B discharge capacity is shown in FIG. 11b, and the Group C discharge capacity is shown in FIG. 11c. Both Groups A and B show good stability of discharge capacity, while Group C shows significant variation in discharge capacity. While not wishing to be bound by any particular theory of operation, the Group C cell-to-cell variations may be due to wetting or EEI formation issues.

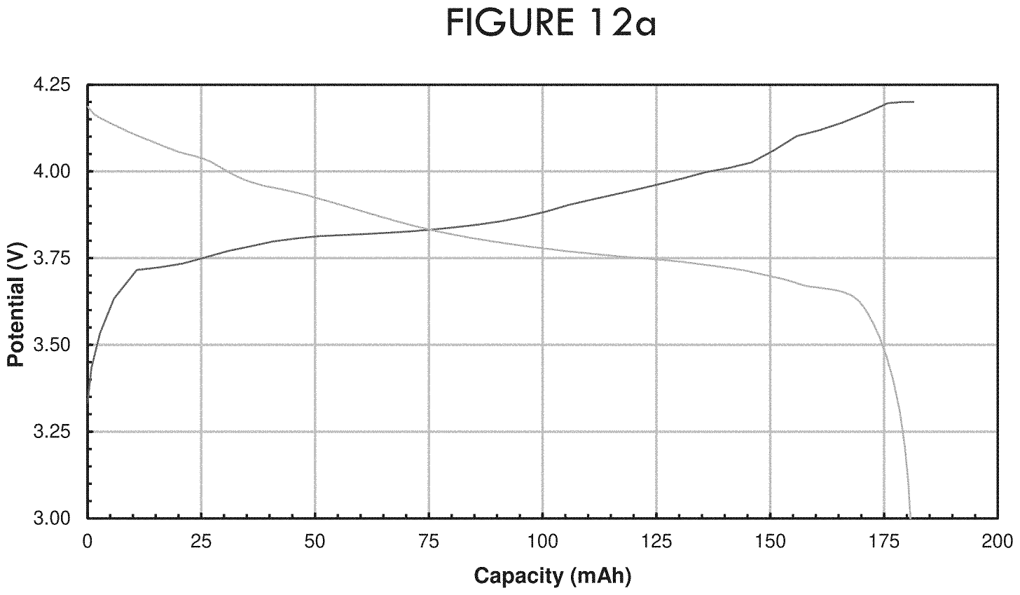

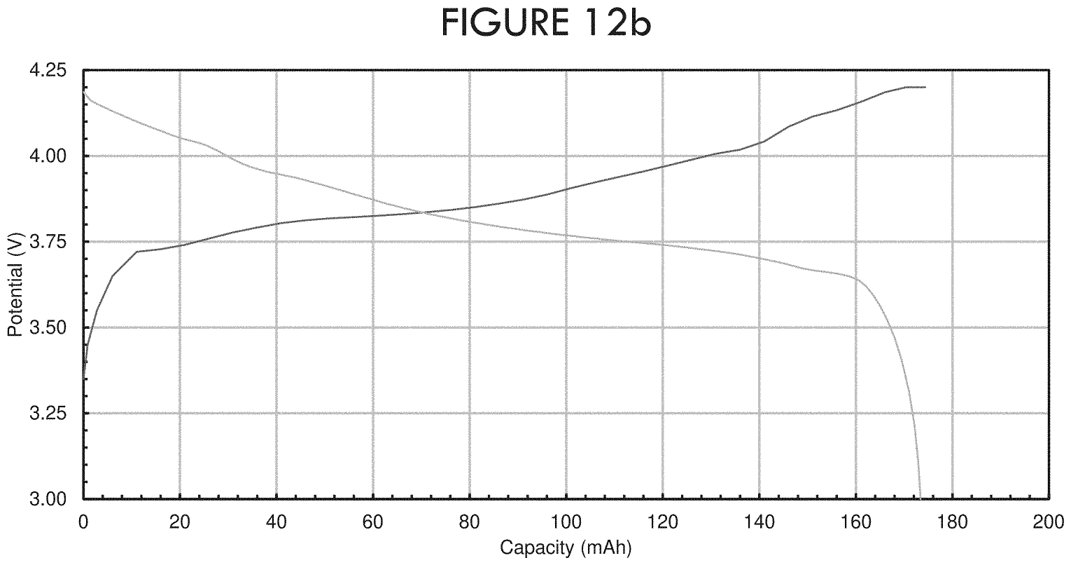

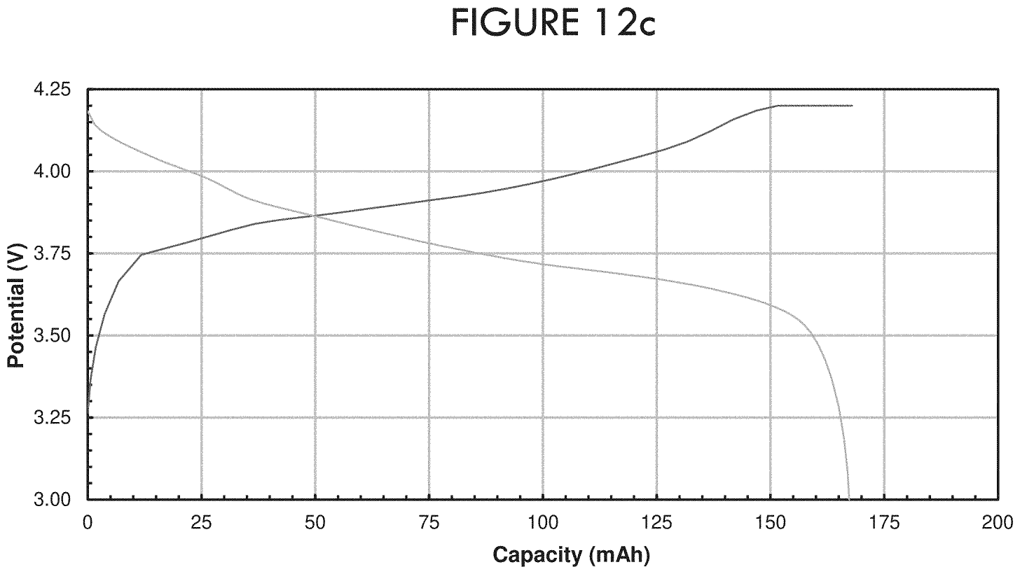

The final stabilization voltage profiles of the cells were measured for each of the groups for the period after step 850. The Group A final stabilization voltage profiles are shown in FIG. 12a, the Group B final stabilization voltage profiles are shown in FIG. 12b, and the Group C final stabilization voltage profiles are shown in FIG. 12c. All groups show similar profiles.

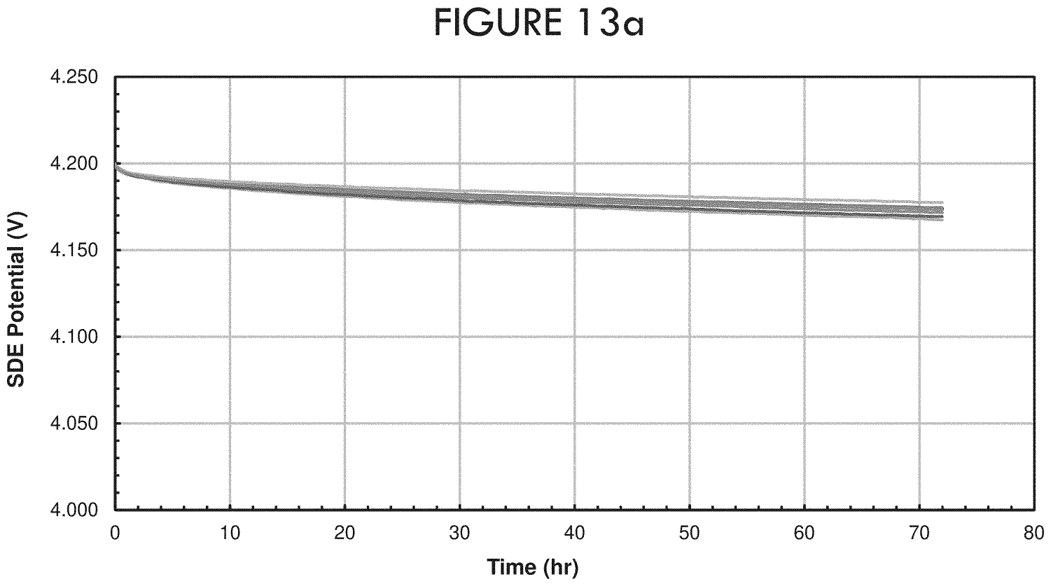

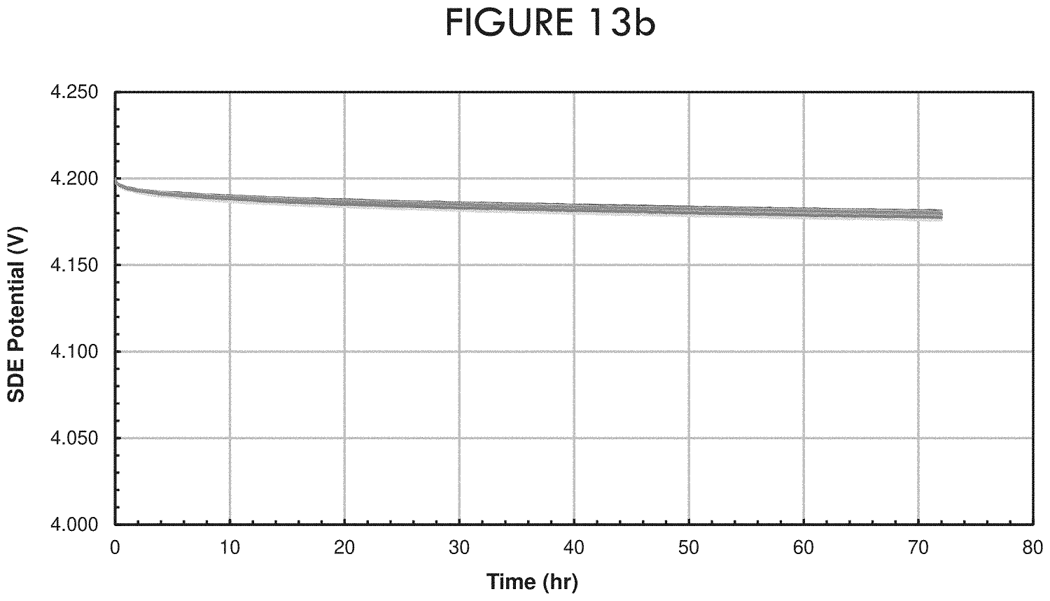

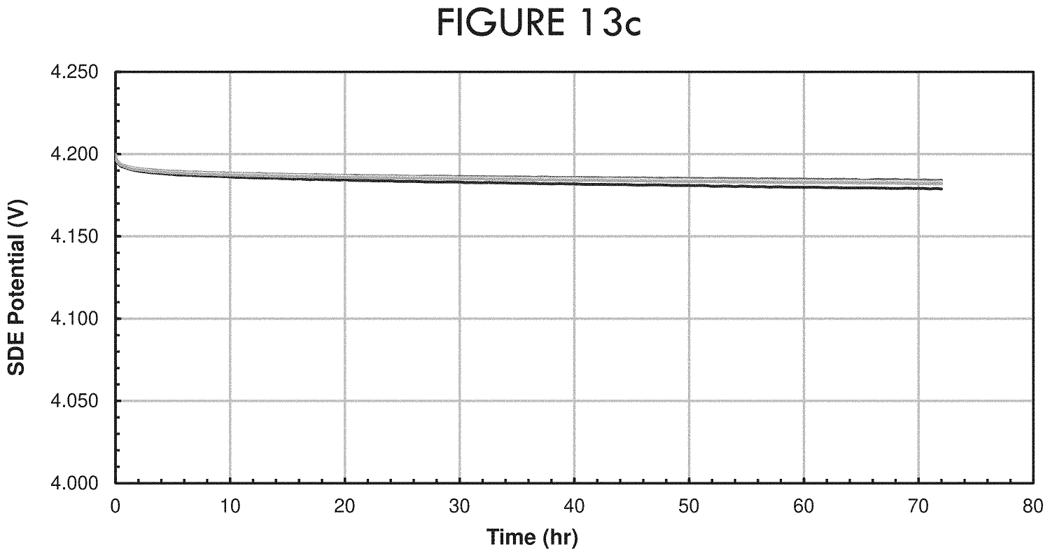

At self-discharge step 860, the self-discharge evaluation potentials of the cells were measured for each of the groups. The Group A self-discharge evaluation potential is shown in FIG. 13a, the Group B self-discharge evaluation potential is shown in FIG. 13b, and the Group C self-discharge evaluation potential is shown in FIG. 13c. All groups show good self-discharge evaluation potential.

High Temperature Storage Test

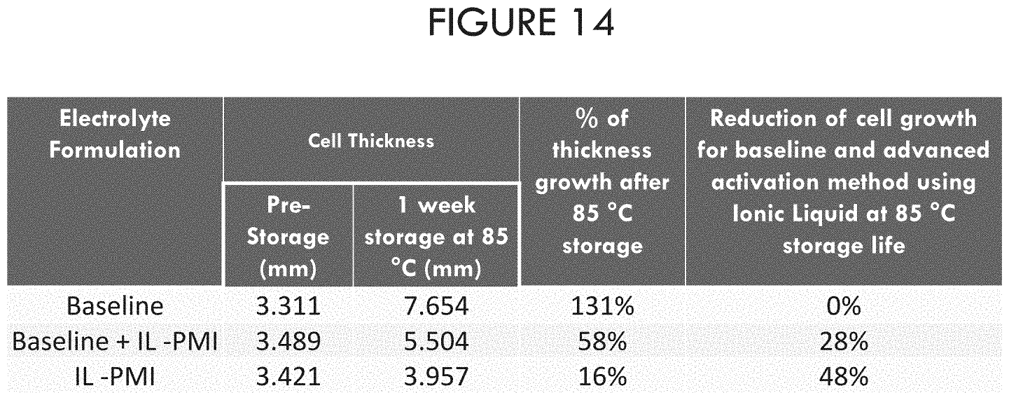

Because swelling of cells is a known issue during storage of cells at high temperatures, three cells from each group were charged to 4.2 V (100% state-of-charge of the cell) at 30 mA, then stored at 85° C. for one week. After one week of storage at 85° C., the cells were allowed to return to room temperature, and the cell thickness was measured using the parallel plate measurement method. The results are summarized in the table shown in FIG. 14. When only standard (Group A) electrolytes are used, the cells grow by 131%. Using a standard electrolyte in combination with the PMP-based ionic liquid (Group B), show only 58% growth after 1 week of storage at 85° C. Using only the PMP-based ionic liquid (Group C), the cells only grew by 16% after one week of storage at 85° C. These results reflect how the multi-stage activation achieves both stable performance and significantly reduces growth during high temperature storage.

### CONCLUSION

It will be understood that many additional changes in the details, materials, steps and arrangement of parts, which have been herein described and illustrated to explain the nature of the subject matter, may be made by those skilled in the art within the principle and scope of the invention as expressed in the appended claims. The steps of the methods described above may be performed in any order unless the order is restricted in the discussion. Any element of any embodiment may be used in any other embodiment and/or substituted for an element of any other embodiment unless specifically restricted in the discussion.

1. An activation method for a cell comprising:
introducing a first electrolyte into a cell having one or more electrodes;
conditioning the cell by activating the cell with the first electrolyte to form an electrode-electrolyte interface on one or more of the electrodes in the cell;
removing the first electrolyte from the cell;
introducing a second electrolyte into the cell, where the second electrolyte has a different composition from the first electrolyte; and
activating the cell with the second electrolyte.

2. The activation method of claim 1, wherein the activation method makes the cell appropriate for use in an extreme condition.

3. The activation method of claim 2, wherein the activation procedure makes the cell appropriate for use in high temperatures.

4. The activation method of claim 3, wherein the cell is a liquid electrolyte cell.

5. The activation method of claim 4, wherein the first electrolyte includes a lithium-ion battery electrolyte.

6. The activation method of claim 5, wherein the second electrolyte includes an ionic liquid-based electrolyte.

7. The activation method of claim 6, wherein the second electrolyte includes ethyl methyl carbonate.

8. The activation method of claim 6, wherein the second electrolyte includes a PMI based ionic liquid.

9. The activation method of claim 4 further comprising drying the cell prior to the step of introducing the second electrolyte into the cell.

10. The activation method of claim 9, wherein the cell is vacuum dried.

11. A refurbishment method for a cell comprising:
removing an original electrolyte from the cell;
introducing a second electrolyte into the cell; and
activating the cell with the second electrolyte.

12. The refurbishment method of claim 11, wherein the second electrolyte is different from the original electrolyte.

13. The refurbishment method of claim 12, wherein the second electrolyte includes the original electrolyte.

14. A cell comprising:
a housing;
a cathode and an anode disposed in the housing;
an electrolyte disposed in the housing and in contact with the cathode and the anode;
an electrode-electrolyte interface formed on at least one of the cathode and the anode, wherein the electrode-electrolyte interface is configured to enhance operation of the cell.

15. The cell of claim 14, wherein the electrode-electrolyte interface is configured to enhance the operation of the cell in an extreme condition.

16. The cell of claim 15, wherein the extreme condition is high temperatures.

17. The cell of claim 14, wherein the electrolyte is a liquid electrolyte.

18. The cell of claim 17 further comprising a pouch structure, wherein the cathode, the anode, and the electrolyte are disposed at least partially within the pouch.

19. The cell of claim 18, wherein the pouch includes at least one port configured to facilitate removing and replacing the liquid electrolyte.

20. The claim of claim 15, wherein the electrolyte includes an ionic liquid-based electrolyte.
